(19) United States
(12) Patent Application Publication
(10) Pub. No.: US 2026/0310980 A1
(43) Pub. Date: Oct. 8, 2026

(54) AUTOMATIC TUNING OF LLM PROMPTS

(71) Applicant: Microsoft Technology Licensing, LLC, Redmond, WA (US)

(72) Inventors: Shanu KUMAR, Bengaluru (IN); Shubhanshu KHANDELWAL, Hyderabad (IN); Akhila YESANTARAO VENKATA, Bengaluru (IN); Manish GUPTA, Hyderabad (IN); Parag AGRAWAL, Bengaluru (IN)

(21) Appl. No.: 19/098,084

(22) Filed: Apr. 2, 2025

(51) Int. Cl. G06N 3/092; G06F 16/242; G06N 3/0475

(52) U.S. Cl. CPC G06N 3/092; G06F 16/242; G06N 3/0475

(57) ABSTRACT

The technology described herein automatically tunes large language model (LLM) prompts for improved performance. The system receives an LLM prompt as input, optimizes it, and outputs a more effective prompt. The optimization process involves converting the prompt into a hierarchical prompt tree, which organizes the prompt into distinct sections and subsections. This structured format allows for systematic refinements targeting specific components without altering the entire prompt. The system uses an actor/critic learning model, where the critic evaluates the prompts generated by the actor and provides feedback to guide future prompt generation decisions. The actor executes actions based on the feedback, continuously improving its performance. The iterative process generates replacement prompts, assigns quality scores, and selects high-quality prompts for further optimization.

### CROSS-REFERENCE TO RELATED APPLICATIONS

None.

### BACKGROUND

Neural networks are a key component of artificial intelligence and are used in a wide range of applications, from image recognition to natural language processing. Large neural networks (NNs), such as large language models (LLMs) have been widely adopted, both in academia and in the industry. A LLM is a type of artificial intelligence model that has been trained on a vast amount of text data. It may learn to predict the next word in a sentence by understanding the context provided by the preceding words. This ability allows it to generate human-like text, given some initial input, such as a prompt. LLMs, such as a Generative Pre-training Transformer (GPT) model, may have billions of parameters that are fine-tuned during training, enabling them to capture complex patterns in language use. They can answer questions, write essays, summarize texts, translate languages, and even generate code.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The technology described herein automatically tunes an LLM prompt for improved performance. The technology described herein receives an LLM prompt as input, optimizes it, and outputs a more effective LLM prompt. The technology described herein optimizes prompt systems for LLMs. The input to a model can include a draft prompt to be optimized, training datasets and validation datasets. Test datasets may be generated during training. The training and validation datasets may each be composed of pairs (x, y) where x represents a potentially multidimensional list of inputs and y is the corresponding expected list of outputs that is ideally generated by the LLM in response to the draft prompt combined with the inputs x. The primary objective of the optimization process may be to find an optimal prompt that maximizes a performance metric, Q (e.g., accuracy), on the validation dataset using a target LLM (M). Alternatively or additionally, an optimal prompt may maximize an efficiency metric.

In aspects, the technology uses an actor/critic learning system to optimize the prompt. This system comprises two primary components: the critic and the actor. The critic evaluates the prompts generated by the actor, provides feedback that guides the actor's future prompt generation decisions. The actor, on the other hand, is responsible for executing actions based on the feedback received from the critic. The interaction between these two components creates a dynamic learning environment where the actor continuously improves its performance by learning from the critic's evaluations. By leveraging the critic's assessments, the actor can refine its prompt generation strategies to achieve optimal prompts.

Instead of working with the prompt directly, in aspects, the prompt may be converted to a hierarchical prompt tree that includes nodes and edges. Each node represents a specific component or segment of the prompt, such as instructions, headings, examples, or lists. The set of edges defines the containment relationship between two nodes (which node is contained within which parent node). The actor and critic model may then evaluate the hierarchical prompt tree instead of the actual prompt.

The technology may use an iterative process. In a first iteration, a plurality of replacement prompts may be generated. In a second iteration, the replacement prompts serve as the input and are used to generate a second plurality of replacement prompts. In aspects, each replacement prompt may be assigned a quality score using the validation dataset. Replacement prompts that receive a higher quality score may be selected as seeds for the next iteration. Replacement prompts with a comparatively lower score may be omitted.

### BRIEF DESCRIPTION OF THE DRAWINGS

The technology described herein is illustrated by way of example and not limitation in the accompanying figures in which like reference numerals indicate similar elements and in which:

FIG. 1 is a diagram of a computing system suitable for implementations of the technology described herein;

FIG. 2 is a block diagram of an example operating environment for tuning a prompt, in accordance with an aspect of the technology described herein;

FIG. 3 is a block diagram illustrating a prompt and hierarchical prompt tree, in accordance with an aspect of the technology described herein;

FIG. 4 is a flow diagram showing a method of tuning a prompt, in accordance with an aspect of the technology described herein;

FIG. 5 is a flow diagram showing a method of tuning a prompt, in accordance with an aspect of the technology described herein;

FIG. 6 is a flow diagram showing a method of tuning a prompt, in accordance with an aspect of the technology described herein; and

FIG. 7 is a block diagram showing a computing device suitable for implementations of the technology described herein.

### DETAILED DESCRIPTION

The various technologies described herein are set forth with sufficient specificity to meet statutory requirements. However, the description itself is not intended to limit the scope of this patent. Rather, the inventors have contemplated that the claimed subject matter might also be embodied in other ways, to include different steps or combinations of steps like the ones described in this document, in conjunction with other present or future technologies. Moreover, although the terms “step” and/or “block” may be used herein to connote different elements of methods employed, the terms should not be interpreted as implying any order among or between various steps herein disclosed unless and except when the order of individual steps is explicitly described.

The technology described herein automatically tunes (e.g., optimizes) an LLM prompt for improved performance. The technology described herein receives an LLM prompt as input, optimizes it, and outputs a more effective LLM prompt. In commercial use, prompts may include a very detailed set of instructions or policies to be followed by the LLM. Optimizing these detailed and long prompts is non-trivial as various aspects such as order, structure, etc. can affect the performance of the LLM using that prompt. Simply put, a bad prompt will produce a bad result. This can result in significant rework by the LLM as users attempt to provide additional ad hoc instructions to get a better output. Hence, having an automatic prompt tuner specifically developed to optimize long prompts provides considerable efficiency for the LLM system by reducing operation cycles that occur as users attempt to refine a prompt.

In aspects, the prompt tuner optimizes commercial prompts. Commercial prompts are intended for reuse by an application and may be written by developers for the application to produce a result. The commercial prompt may be obscured from users of the application who may not even realize that the output received is generated by an LLM using the prompt. The commercial prompt includes instructions for an LLM, but may be missing at least some user data, which may be represented in the prompt by a placeholder. Placeholders in a prompt are used to indicate where specific information should be inserted. Placeholders act as markers that the LLM model can recognize and replace with the appropriate data when generating a response.

Enhancing the efficiency of prompt systems reduces computational costs and accelerates response times, which may be important for scaling LLM applications in real-time use cases. By optimizing prompt structures and minimizing token usage without sacrificing performance, prompt systems can handle complex tasks more effectively and sustain higher throughput, making them suitable for demanding environments such as customer service, data analysis, and interactive AI platforms.

The technology described herein optimizes prompt systems for LLMs. The input to the model can include a draft prompt to be optimized, training datasets and validation datasets. Test datasets may be generated during training. The training and validation datasets may each be composed of pairs (x, y) where x represents a potentially multidimensional list of inputs and y is the corresponding expected list of outputs that is ideally generated by the LLM in response to the draft prompt combined with the inputs x. The primary objective of the optimization process may be to find an optimal prompt that maximizes a performance metric, Q (e.g., accuracy), on the validation dataset using a target LLM (M). A secondary objective may be to optimize prompt efficiency E. A prompt optimized for one LLM may need to be re-optimized on a different LLM.

In aspects, the technology uses an actor/critic learning system to optimize the prompt. This system comprises two primary components: the critic and the actor. The critic evaluates the prompts generated by the actor, provides feedback that guides the actor's future prompt generation decisions. The actor, on the other hand, is responsible for executing actions based on the feedback received from the critic. The interaction between these two components creates a dynamic learning environment where the actor continuously improves its performance by learning from the critic's evaluations. By leveraging the critic's assessments, the actor can refine its prompt generation strategies to achieve optimal prompts.

Instead of working with the prompt directly. In aspects, the prompt may be converted to a hierarchical prompt tree that includes nodes and edges. The set of nodes, each represent a specific component or segment of the prompt, such as instructions, headings, examples, or lists. The set of edges defines the containment relationship between two nodes (which node is contained within which parent node). The actor and critic model may then evaluate the hierarchical prompt tree instead of the actual prompt.

The critic model evaluates the prompt's effectiveness and identifies areas for refinement. The critic model provides feedback on how well the prompt guides the LLM to perform as intended. This feedback, known as reflections, may be generated in two types, each targeting different aspects of the prompt's structure and content. The first type, preliminary reflection, focuses on the structural and semantic clarity of the prompt before it is tested on the LLM. The second type of reflection is error assessment reflection. An error assessment reflection is generated after evaluating the prompt on the LLM's predictions, focusing on specific errors in the output. Once reflections are generated, they may be aggregated to ensure that the actor model can apply changes systematically and effectively.

The actor model is responsible for translating the critic model's reflections into actionable modifications. It processes the aggregated feedback from both preliminary and error assessment reflections to determine and apply specific changes to the prompt. These changes are tailored to enhance the clarity, coherence, and effectiveness of the prompt, ensuring that it better aligns with the task requirements and improves the model's performance. The actor model may take one or more of several predefined actions.

The technology may use an iterative process. In a first iteration, a plurality of replacement prompts may be generated. In a second iteration, the replacement prompts serve as the input and are used to generate a second plurality of replacement prompts. In aspects, each replacement prompt may be assigned a quality score using the validation data. Replacement prompts that receive a higher quality score may be selected as seeds for the next iteration. Replacement prompts with a comparatively lower score may be omitted. In aspects, an explore/exploit methodology may be used to select replacement prompts for seed usage. In general, the explore/exploit methodology will favor high quality replacement prompts while selecting some lower scoring replacement prompts for the purpose of exploration.

As large language models become increasingly central to solving complex problems, the challenge of optimizing prompt systems has stymied progress. These systems often contain long or complex unstructured prompts, consist of chained and interlinked prompts, or involve multi-agent systems. Manually optimizing these systems is cumbersome and requires significant human effort. The technology described herein helps solve these problems through automated prompt optimization.

The technologies herein are described using key terms wherein definitions are provided. However, the definitions of key terms are not intended to limit the scope of the technologies described herein.

In one example, a neural network is a computational model that consists of layers of nodes, or “neurons,” each receiving input, processing it, and passing the output to the next layer. Neural networks can include different types of layers. Example layer types include convolutional, activation, pooling, fully connected, batch normalization, dropout, recurrent layers, feedforward layers, embedding layers, and attention layers.

In one example, a prompt in the context of a LLM is the combination of textual instructions and input provided to guide the LLM's output. The textual instructions can range from simple questions to detailed descriptions or specific tasks. A prompt serves as the initial textual instructions and input that the LLM uses to generate a relevant response or completion. For example, in a translation task, a prompt might be: “Translate the following sentence from English to Spanish: The cat jumped over the moon.” In this example, “Translate the following sentence from English to Spanish” is the instruction and “The cat jumped over the moon” is the input. The model would then generate the translation based on this instruction and input. In practice, prompts can include instructions, questions, input data, and examples. They are designed to elicit a desired response from the LLM, and their effectiveness can significantly impact the model's performance

In one example, several sections may be included in a prompt to ensure clarity and effectiveness. Example sections found in a prompt can include an introduction, instructions, examples, formatting guidelines, evaluation criteria, and additional information possibly in the form of lists and bullet points. The introduction section provides a brief overview of the prompt's purpose and context. It sets the stage for the rest of the prompt by explaining what the user is expected to do. The instructions section includes detailed instructions given to guide the LLM on how to respond to the prompt. This may include specific tasks, questions to answer, or actions to take. Providing examples can help clarify the instructions and show the LLM what a good response looks like. Examples can be in the form of sample answers or scenarios. A formatting guidelines section outlines any specific formatting requirements for the response, such as word count, structure, or style. An evaluation criteria may help an LLM understand how its responses will be assessed, this section lists the criteria that will be used for evaluation. This can include aspects like relevance, accuracy, creativity, and completeness. Any extra information that might be useful for the LLM to know may be included here. This additional information could be background information, resources, or references. The conclusion wraps up the prompt by reiterating key points and encouraging the LLM to begin its response.

In an example, a commercial prompt is a type of prompt that includes instructions, but is missing input, which is instead represented by a placeholder. Placeholders in a prompt are used to indicate where specific information should be inserted. They act as markers that the model can recognize and replace with the appropriate data when generating a response. This technique is useful for creating dynamic and context-specific outputs. Placeholders are typically enclosed in curly braces { } or other delimiters to distinguish them from regular text. For example, {name}, {date}, {location}. When the prompt is used, the actual values for these placeholders are provided either programmatically or manually. The actual values are described as input herein. The model replaces the placeholders with the provided information to generate a coherent and contextually accurate response.

In an example, a prompt chain includes two or more prompts where the output generated by an LLM in response to a first prompt becomes, at least, part of the input used to generate a second LLM output in response to a second prompt.

Having briefly described an overview of aspects of the technology described herein, an operating environment in which aspects of the technology described herein may be implemented is described below to provide a general context for various aspects.

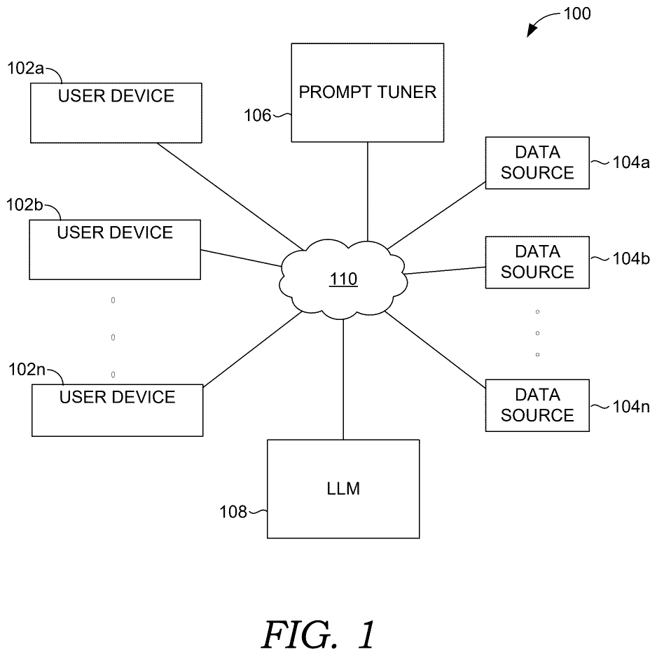

Turning now to FIG. 1, a block diagram is provided showing an example operating environment 100 in which some embodiments of the present disclosure can be employed. This and other arrangements described herein are set forth only as examples. Other arrangements and elements (for example, machines, interfaces, functions, orders, and groupings of functions) can be used in addition to or instead of those shown, and some elements can be omitted altogether for the sake of clarity. Further, many of the elements described herein are functional entities that are implemented as discrete or distributed components or in conjunction with other components, and in any suitable combination and location. Various functions described herein as being performed by one or more entities are carried out by hardware, firmware, and/or software. For instance, some functions are carried out by a processor executing instructions stored in memory.

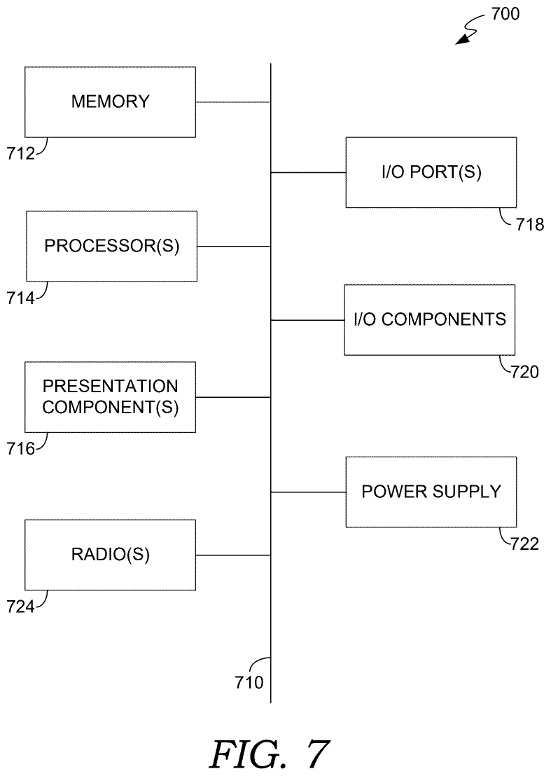

Among other components not shown, example operating environment 100 includes several user computing devices, such as user devices 102a through 102n; several data sources, such as data sources 104a and 104b through 104n; tuning server 106; LLM 108; and network 110. Each of the components shown in FIG. 1 is implemented via any type of computing device, such as computing device 700 illustrated in FIG. 7. In one embodiment, these components communicate with each other via network 110, which includes, without limitation, one or more local area networks (LANs) and/or wide area networks (WANs). In one example, network 110 comprises the internet, intranet, and/or a cellular network, amongst any of a variety of possible public and/or private networks.

Any number of user devices, servers, and data sources can be employed within operating environment 100 within the scope of the present disclosure. Each may comprise a single device or multiple devices cooperating in a distributed environment. For instance, tuning server 106 may be provided via multiple devices arranged in a distributed environment that collectively provides the functionality described herein. Additionally, other components not shown may also be included within the distributed environment.

User devices 102a, 102b, through 102n can be client user devices on the client-side of operating environment 100, while tuning server 106 and LLM 108 (which may run in a data center) can be on the server-side of operating environment 100. The user devices may be described as client devices and/or edge devices herein. Tuning server 106 can comprise server-side software designed to work in conjunction with client-side software on user devices 102a through 102n to implement any combination of the features and functionalities discussed in the present disclosure. In one aspect, the tuning server 106 generates an optimized prompt that is presented through one or more of the user devices 102a through 102n. This division of operating environment 100 is provided to illustrate one example of a suitable environment and there is no requirement for each implementation that any combination of tuning server 106 and user devices and 102a through 102n remain as separate entities.

In some embodiments, user devices 102a through 102n comprise any type of computing device capable of use by a user. For example, in one embodiment, user devices 102a through 102n are the type of computing device 700 described in relation to FIG. 7. By way of example and not limitation, a user device is embodied as a personal computer (PC), a laptop computer, a mobile device, a smartphone, a tablet computer, a virtual-reality (VR) or augmented-reality (AR) device or headset, a handheld communication device, an embedded system controller, a consumer electronic device, a workstation, any other suitable computer device, or any combination of these delineated devices.

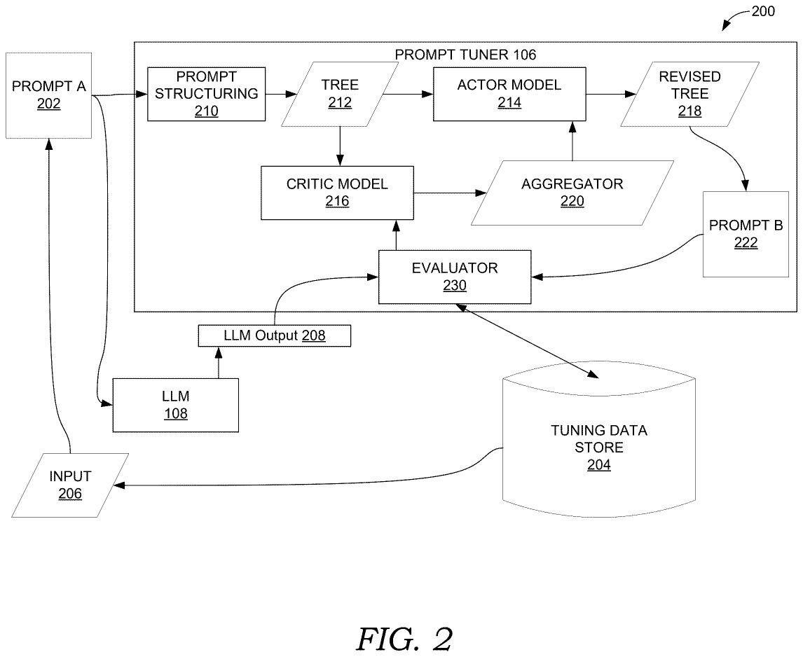

In some embodiments, data sources 104a and 104b through 104n comprise data sources and/or data systems, which are configured to make data available to any of the various constituents of operating environment 100 or environment 200 described in connection to FIG. 2. The data sources 104a and 104b through 104n may include training data, validation data, and test data use to optimize a prompt. The data sources 104a and 104b through 104n can also store optimized prompts for later use. Certain data sources 104a and 104b through 104n are discrete from user devices 102a through 102n and tuning server 106 or are incorporated and/or integrated into at least one of those components. In one embodiment, one or more of data sources 104a and 104b through 104n comprise one or more sensors, which are integrated into or associated with one or more of the user device(s) 102a through 102n or tuning server 106. For example, the data sources could include a web camera used to interact with a virtual environment.

The LLM 108 may run on a server. The tuning server 106 may use the LLM 108 for various tasks. In one example, a “language model” is a set of statistical or probabilistic functions that performs Natural Language Processing (NLP) to understand, learn, and/or generate human natural language content. A language model is one example of a neural network. For example, a language model can be a tool that determines the probability of a given sequence of words occurring in a sentence (e.g., via NSP or MLM) or natural language sequence. Simply put, it can be a tool which is trained to predict the next word in a sentence. A language model is called a large language model (“LLM”) when it is trained on enormous amount of data. Some examples of LLMs are GOOGLE's BERT and OpenAI's GPT-2 and GPT-3. GPT-3, and GPT-4 (which has over 175 billion parameters trained on over 570 gigabytes of text), GPT-40, Claude 3.7 Sonnet, Gemini 2.0, Grok 3, and DeepSeek R-1. These models have capabilities ranging from writing an essay to generating complex computer codes-all with limited to no supervision. Accordingly, an LLM is a deep neural network that is very large (billions to hundreds to trillions of parameters) and understands, processes, and produces human natural language by being trained on massive amounts of text. These models can predict future words in a sentence letting them generate sentences like how humans talk and write. In some embodiments, the LLM is pre-trained (e.g., via NSP and MLM on a natural language corpus to learn English) without having been fine-tuned but rather uses prompt engineering/prompting/prompt learning using one-shot or few-shot examples.

A language model may perform various tasks, such as machine translation, natural language summary, question answering, and sentiment analysis. A “natural language summary” as described herein refers to text summarization. Text summarization (or automatic summarization or NLP text summarization) is the process of breaking down text (e.g., several paragraphs) into smaller text (e.g., one sentence or paragraph). In other words, text summarization is the process of distilling the most important information from a source (or sources) to produce an abridged version for a particular user (or users) and task (or tasks). This method extracts vital information while also preserving the meaning of the text. This reduces the time required for grasping lengthy pieces such as articles without losing vital information, for example. For example, using extraction summarization, some embodiments, using NLP, detect key chunks of natural language text, extracting or cutting them out, then stitching them back together to create a shortened form of the dataset. For instance, a sentence in the dataset may read, “I'm heading to the supermarket by taking Ray Road. Hopefully there will not be as much traffic at that time. I'm going to buy fruit.” Extraction summarization may work by reducing the characters to “I'm heading to the supermarket. I'm going to buy fruit.” In another example, abstractive summarization works by generating new sentences (or other natural language characters) from the original dataset. For example, using the original dataset described above, the summarization may be, “I'm heading to the store to buy fruit,” where “store” is a new word input into the new sentence (e.g., based on NLP semantic analysis and/or Named Entity Recognition NER and “I'm going” is removed from the original sentence. NER is an information extraction technique that identifies and classifies tokens/words or “entities” in natural language text into predefined categories. Such predefined categories may be indicated in corresponding tags or labels, which can be used in summaries. Entities can be, for example, names of people, specific organizations, specific locations, specific times, specific quantities, specific monetary price values, specific percentages, specific pages, and the like.

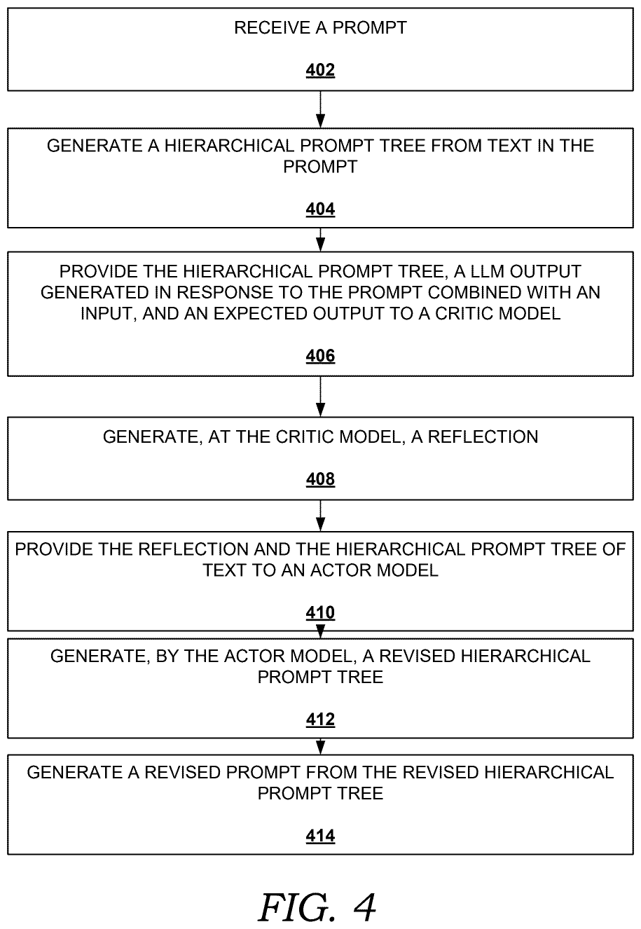

Operating environment 100 can be utilized to implement one or more of the components of environment 200, as described in FIG. 2. Operating environment 100 can also be utilized for implementing aspects of methods 400, 500, and 600 in FIGS. 4, 5, and 6, respectively.

Referring now to FIG. 2 with FIG. 1, a block diagram is provided showing aspects of an example prompt tuning environment 200 suitable for implementing some embodiments of the disclosure and designated generally as environment 200. The environment 200 includes the content prompt tuning server 106, LLM 108 and tuning data store 204. At a high level, the tuning server 106 receives a prompt 202 that is to be optimized along with training data and validation data, which may be stored in the tuning data store 204. The tuning server 106 generates a revised prompt (prompt B 222), which may be part of a series of revised prompts generated by the tuning server 106. The revised prompt may be validated using the validation data. If the revised prompt generates improved results, it may be stored as test data in the tuning data store 204. The revised prompt may then serve as the starting point for a second iteration. The tuning process may repeat until a final prompt is generated. The iterative tuning process may end when the performance of revised prompts stops improving. Alternatively, the iterative tuning may stop after a designated number of iterations.

The environment 200 represents only one example of a suitable computing system architecture. Other arrangements and elements can be used in addition to or instead of those shown, and some elements may be omitted altogether for the sake of clarity. Further, as with operating environment 100, many of the elements described herein are functional entities that may be implemented as discrete or distributed components or in conjunction with other components, and in any suitable combination and location. These components may be embodied as a set of compiled computer instructions or functions, program models, computer software services, or an arrangement of processes carried out on one or more computer systems.

In one embodiment, the functions performed by components of environment 200 are associated with using a ML model. These components, functions performed by these components, and/or services carried out by these components may be implemented at appropriate abstraction layer(s) such as the operating system layer, application layer, and/or hardware layer of the computing system(s). Alternatively, or in addition, the functionality of these components, and/or the embodiments described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs). Additionally, although functionality is described herein with regards to specific components shown in example environment 200, it is contemplated that in some embodiments functionality of these components can be shared or distributed across other components and/or computer systems.

The tuning server 106 includes a prompt structuring component 210, an actor model 214, a critic model 216, a reflection aggregator 220, and an evaluator 230. A starting point for the prompt tuning system includes a prompt 202 to be optimized. In aspects, the prompt 202 is communicated to the prompt structuring component 210 and is also combined with input 206 and sent to the LLM 108 to produce an LLM output 208. In an aspect, the prompt includes one or more placeholders for the actual values from the input 206 to be inserted when executing the prompt.

The prompt structuring component 210 transforms the prompt into a hierarchical prompt tree 212. This transformation organizes the prompt into distinct sections and subsections, allowing for systematic refinements targeting specific components without altering the entire prompt. The structured format provides a clear representation of relationships between various parts of the prompt, facilitating focused optimizations and enhancing interpretability.

The unstructured prompt PPP may be represented as a tree T=(N, E), where:

N: The set of nodes, each representing a specific component or segment of the prompt, such as instructions, headings, examples, or lists.

E: The set of edges, which defines the containment relationship between two nodes (which node is contained within which parent node).

Each node in the hierarchical prompt tree 212 serves a unique role in the prompt's structure, allowing the system to apply specific actions to nodes based on their types. Common node types include, but are not limited to, instruction nodes, heading nodes, example nodes, and list and bullet points. Instruction nodes contain task-specific directives guiding the LLM on the required task. Heading nodes organize the overall structure and provide context by grouping related sections together. Example nodes demonstrate specific cases or scenarios, clarifying complex instructions or offering templates for expected responses. List and bullet points represent ordered or unordered information, such as steps in a process or lists of guidelines.

The hierarchical prompt tree 212 enables precise, node-specific optimizations. By structuring prompts into this format, the technology described herein can make targeted modifications. Targeted modifications allow specific sections of the prompt to be refined without impacting unrelated sections, thereby preserving the prompt's integrity. The structure also provides a clear view of how sections interact, facilitating the application of meaningful and context-aware optimizations. The hierarchical prompt tree 212 also has efficiency benefits. This structured approach reduces token usage in the optimization process by narrowing the focus to relevant nodes and edges, thereby minimizing unnecessary modifications.

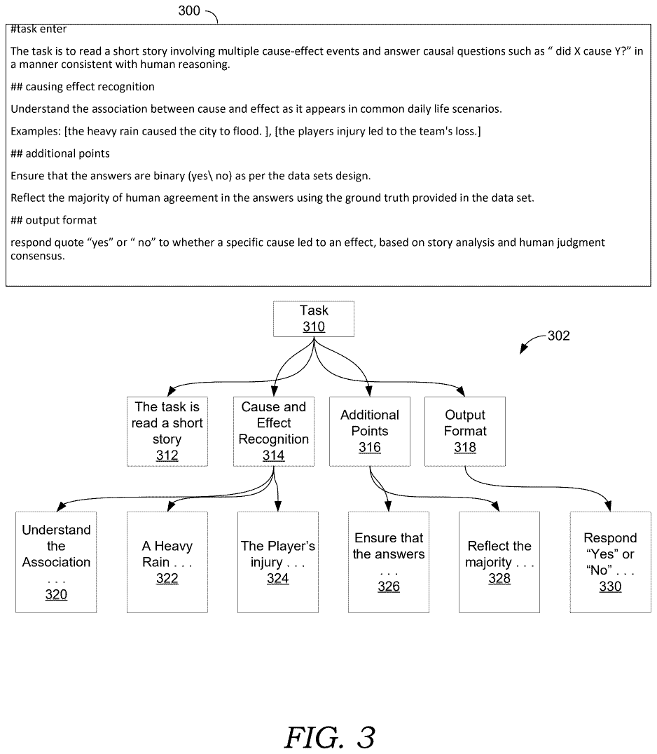

An example prompt 300 and example hierarchical prompt tree 302 are shown in FIG. 3. The parent node 310 is a task node. On the second hierarchical level multiple aspects of the task are identified. The node 312 explains the task is to read a short story. The node 314 explains that the task is to also recognize cause and effect within the story. The node 316 introduces the concept of additional points to help with the task. The node 318 introduces an output format. The node 312, the node 314, the node 316, and the node 318 are all connected by edges to node 310 in a child relationship. The node 312 has no parent relationships to child nodes. In contrast, the node 314, the node 316, and the node 318 all have child nodes.

The third hierarchal level includes a node 320, a node 322, a node 324, a node 326, a node 328, and a node 330. The node 320, the node 322 and the node 324 all have the node 314 as a parent node. The node 320 provides details about understanding the association. The node 322 is an example node that provides an example association. The node 324 is another example node that provides a second example association. The node 326 and the node 328 are child nodes of the node 316. The node 326 explains that the answers should be binary. The node 328 explains that the answer should reflect a majority opinion. The node 330 is a child node of the node 318. The node 330 explains that the response should be yes or no, which Provides more detail about a desired output format.

The prompt structuring component 210 may comprise an application that sends a structuring prompt and the prompt 202 to the LLM 108 and receives the hierarchical prompt tree 212 in response. The hierarchical prompt tree 212 may then be communicated to the actor model 214 and the critic model 216. The structuring prompt used by the prompt structuring component 210 may include a task explanation, a definition of different node types, one or more example outputs, a specified output format, along with other instructions. The prompt structuring component 210 may receive the prompt 202 without input 206.

A critic actor machine learning system is an architecture designed to optimize decision-making processes in various applications. This system comprises two primary components: the critic model 216 and the actor model 214. The critic model 216 evaluates the prompts generated by the actor model 214, providing feedback that guides the actor model's 214 future prompt generation attempts. The actor model 214, on the other hand, is responsible for generating tree modifications based on the feedback received from the critic model 216. The interaction between these two components creates a dynamic learning environment where the critic model 216 continuously improves the prompts being generated by learning from the critic model's 216 evaluations. By leveraging the critic's assessments, the actor model 214 can refine its strategies to generate optimal prompts.

The critic model receives the hierarchical prompt tree 212 and one or more LLM outputs 208 as input. The LLM output 208 may be generated using training data. The training data includes a series of inputs where each input is matched with an expected LLM output. The expected LLM output may be human generated and represents the desired output when the prompt 102 is combined with the input 206 and communicated to the LLM 108 as its input. A goal of the tuning process is for the output generated through an optimized prompt to match to the desired output. The optimal LLM output may be alternatively described herein as an expected output.

In aspects, all LLM outputs 208 generated in response to a training set of inputs are evaluated by the evaluator 230 for closeness to an expected output. In aspects, only LLM outputs 208 that are classified as incorrect because they do not match the expected output may be communicated to the critic model 216. LLM outputs that match the expected output may be excluded from communication to the critic model because correct outputs provide less opportunity for the tuning operation.

The evaluator 230 may include an application that sends an evaluation prompt to the LLM 108 along with the LLM output 208 and corresponding expected results from the training data. The LLM 108 then performs an evaluation and returns a classification of the output as correct or incorrect. If incorrect, the LM may also specify aspects of the output that are incorrect. The evaluation prompt may include instructions asking the LLM to classify an LLM output as correct or incorrect given an expected output. The evaluation prompt may include criteria for determining what constitutes a correct output and an incorrect output. The evaluation prompt may include also include a specified output format and one or more examples of correct and incorrect output.

The critic model 216 evaluates the prompt's effectiveness and identifies areas for refinement. The critic model 216 provides feedback on how well the prompt guides the LLM to perform as intended. This feedback, known as reflections, may be generated in two types, each targeting different aspects of the prompt's structure and content. Once reflections are generated, they may be aggregated to ensure that the actor model 214 can apply changes systematically and effectively.

The critic model 216 generates two distinct types of reflections, each serving a specific purpose in the optimization process. The first type, preliminary reflection, focuses on the structural and semantic clarity of the prompt 202 before it is tested on the LLM. The critic model 216 independently examines the hierarchical prompt tree 212 for issues related to clarity, organization, completeness, and redundancy. The preliminary reflection does not rely on the model's performance feedback but instead provides general guidance to improve the prompt's readability and coherence. Key elements addressed by preliminary reflection include structural coherence, which involves suggestions to rearrange or rephrase sections to improve logical flow and ease of understanding; completeness, which involves the identification of missing examples, steps, or instructions that could help the LLM better understand the task; and clarity, which involves recommendations for rephrasing or simplifying complex instructions.

The critic model 216 may generate a preliminary reflection using a reflection prompt communicated to the LLM 108 along with the hierarchical prompt tree 212. The reflection prompt may include task guidance, an output format, and example hierarchical prompt trees. Both positive and negative examples of a hierarchical prompt trees may be included.

The second type of reflection is error assessment reflection. An error assessment reflection is generated after evaluating the prompt on the LLM's predictions, focusing on specific errors in the output. Each error assessment reflection is generated for an input-output pair (x, y) where the model's prediction y\hat{ }≠vy, indicating a failure in the prompt's ability to guide the LLM model 108 accurately. An error assessment reflection includes error diagnosis, which involves analyzing why the prompt may have led to an incorrect prediction, including any ambiguities or missing information. It also includes targeted suggestions, which involve recommendations to modify specific nodes or sections in the hierarchical prompt tree 212 to address the error, such as adjusting examples or refining instructions. Additionally, node path identification may be included, which involves pinpointing the specific nodes (e.g., example or instruction nodes) in the hierarchical prompt tree 212 likely responsible for the error, allowing for focused improvements.

The critic model 216 may work on a batch of training data to generate a batch of reflections. The aggregator 220 aggregates reflections to provide a cohesive set of recommendations to the actor model 214. This aggregation ensures that the actor model 214 can apply comprehensive refinements without redundancy or contradiction, balancing the impact of multiple reflections on the same or related nodes. The aggregator 220 aggregates reflections using one of two methods.

The first aggregation method, node reference-based aggregation, groups reflections based on shared references to specific nodes within the hierarchical prompt tree 212. When multiple reflections address the same node, such as an example node with redundant information, they are combined to create a unified set of recommendations for that node. This aggregation approach allows the actor model 214 to apply all relevant reflections to a node in one iteration, preventing piecemeal updates and ensuring a holistic modification.

The second aggregation method, similarity-driven aggregation, groups reflections based on thematic or contextual similarities, such as shared input-output errors or related types of instructions, rather than node references. Similarity-driven aggregation relies on the LLM's ability to identify patterns across reflections that address similar errors or misinterpretations, even if they pertain to different nodes. While this method can uncover broader issues affecting multiple nodes, it may sometimes miss node-specific nuances if reflections may be aggregated primarily on similarity in input or output context.

The aggregator 220 may include an application that communicates one or more aggregation prompts to the LLM 108 along with a batch of reflections. The one aspect, the one or more aggregation prompts ask the LLM 108 to perform the similarity-driven aggregation and/or the node-reference based aggregation. The aggregation prompts may define the similarity-driven aggregation and/or the node-reference based aggregation, specify an output format, provide an output example and provide aggregation examples.

The actor model 214 is responsible for translating the critic model's 216 reflections into actionable modifications within the hierarchical prompt tree. It processes the aggregated feedback from both preliminary and error assessment reflections to determine and apply specific changes to the hierarchical prompt tree. Changes to the hierarchical prompt tree will result in a new prompt. These changes are tailored to enhance the clarity, coherence, and effectiveness of the prompt, ensuring that it better aligns with the task requirements and improves the model's performance.

The actor model 214 may operate on a partial hierarchical prompt tree, which includes only the nodes relevant to the critic model's 216 reflections, along with their essential parent nodes for context. By focusing only on the relevant parts of the hierarchical prompt tree, the actor model 214 avoids redundant token usage and directs its updates precisely where they are needed. The actor model 214 interprets each reflection to identify specific issues and then generates a sequence of actions that address these issues in a coherent and targeted manner. Each action is designed to make structured, incremental changes to the partial hierarchical prompt tree.

The partial hierarchical prompt tree is then reconciled with the hierarchical prompt tree 212 to form a revised hierarchical prompt tree 218. During reconciliation, updated nodes in the partial hierarchical prompt tree replace corresponding nodes in the hierarchical prompt tree 212. The revised hierarchical prompt tree 218 will also include any new nodes added and will not include nodes that were deleted from the hierarchical prompt tree 212.

The actor model 214 possesses a diverse set of pre-defined actions to address various types of issues identified by the critic model 216. In aspects, the actor model 214 is limited to taking the pre-defined actions. These actions are classified based on their intended impact, ranging from content updates and structural adjustments to the addition or removal of examples and nodes.

Structural reordering is one of the pre-defined actions. In an example, structural reordering involves adjusting the order of sibling nodes to improve the logical flow of information, which is commonly applied when sections are out of order and may lead to confusion for the LLM. For instance, moving a “Guidelines” section before the “Examples” section can enhance clarity.

Instruction updates is another pre-defined action. In an example, instruction updates involve modifying the content of a node to add clarity, specificity, or additional guidance. This includes rephrasing instructions, simplifying complex language, or adding new instructions when the existing ones are incomplete. An example of this would be rewriting an ambiguous instruction to make it clearer and easier for the LLM to interpret.

Example addition is another pre-defined action. In an example, example addition entails adding new examples to a node to illustrate additional cases, edge scenarios, or missing variations in the data, which is often used when the Critic identifies gaps in the prompt's coverage. For example, adding an example for an uncommon error type that the LLM frequently misses.

Example deletion is another pre-defined action. In an example, example deletion involves removing outdated, redundant, or irrelevant examples from a node to reduce clutter and prevent confusion. This action is useful when examples are too similar or distract from the main task, such as deleting an example that no longer aligns with the updated task requirements.

Example refinement is another pre-defined action. In an example, the actor model 214 refines existing examples to make them more relevant, concise, or illustrative. This action is applied when examples need slight adjustments to improve their alignment with the prompt's objectives. For instance, updating an example to clarify ambiguous wording or to ensure consistency with new instructions.

Node pruning is another pre-defined action. In an example, the actor model 214 also prunes unnecessary nodes that do not contribute to the task's goal or are repetitive, thereby streamlining the prompt by eliminating superfluous content. An example of this would be deleting a redundant “Background” node that duplicates information already covered elsewhere.

Node expansion is another pre-defined action. In an example, the actor model 214 expands the prompt by adding new nodes to address gaps. This action is particularly useful when additional sections are needed to guide the LLM effectively, such as including “Safety Guidelines” for sensitive tasks. For example, adding a new node for “Error Classification Guidelines” to support a classification task.

Node merging is another pre-defined action. In an example, the actor model 214 merges nodes that have overlapping or redundant content to reduce duplication and improve coherence. This action is often used to simplify the structure when multiple nodes cover similar information, such as merging “Overview” and “Introduction” nodes if they provide the same content.

The actor model 214 processes each reflection and determines the most appropriate action based on the reflection type, whether it is preliminary or error assessment, and the prompt structure. Actions are sequenced to ensure incremental and systematic improvement, and multiple actions may be applied in a single iteration to comprehensively address all relevant issues identified in the aggregated reflections. For each reflection, the actor model 214 may apply single-node actions, which are straightforward adjustments to specific nodes, such as example addition or instruction update. Additionally, multi-node actions may be applied, where changes in one node necessitate adjustments in related nodes to maintain coherence. Once the actions are applied, the revised hierarchical prompt tree 218 the actor model 214 may convert the revised hierarchical prompt tree 218 back into an unstructured prompt format by traversing the updated nodes according of the revised hierarchical prompt tree 218. This refined prompt 222 may become a candidate prompt and tuned just as the original prompt 202 was tuned, continuing the iterative optimization cycle until the refined prompt 222 achieves the desired performance on the validation dataset or meets the stopping criteria. Though only one refined prompt 222 is shown, in aspects, the actor model 214 may generate a plurality of refined prompts by making different changes to the hierarchical prompt tree 212 to form multiple modified hierarchical prompt trees.

Not all refined prompts may be used as starting points for the next iteration. Some refined prompts may be excluded. The evaluator 230 can evaluate refined prompts to determine which prompts should form the next round of inputs to the tuning process and which prompts should be omitted from the process. The evaluator 230 can perform a search process to determine which refined prompts should become inputs. The search process is designed to balance exploration and exploitation during prompt optimization by using a beam search strategy combined with an Upper Confidence Bound (UCB)-based selection mechanism. The UCB-based selection mechanism is a strategy used in reinforcement learning and multi-armed bandit problems to balance exploration and exploitation. The mechanism works by selecting actions based on their estimated rewards and the uncertainty associated with these estimates. Specifically, it calculates an upper confidence bound for the expected reward of each action, which is a combination of the empirical mean reward and a term that accounts for the uncertainty or variance in the reward estimates. This term typically grows logarithmically with the number of times an action has been selected, ensuring that actions with higher uncertainty are more likely to be chosen. By selecting the action with the highest upper confidence bound, the mechanism encourages exploration of less certain actions while still favoring those with higher estimated rewards. This approach helps to minimize regret over time, as it systematically improves the accuracy of reward estimates and optimizes the selection process.

This process ensures that the actor model 214 and critic model 216 iteratively refine prompts while evaluating multiple promising candidates, systematically moving towards an optimal solution. At the beginning of each iteration, a beam (Bₜ) is initialized, containing a set of candidate prompts {P¹ₜ, P²ₜ, . . . , P^{K}ₜ}. Each candidate represents a refined version of the initial prompt, generated during previous iterations. The beam width (K) controls the number of candidates retained and expanded at each step, ensuring a manageable yet diverse set of options. Each candidate prompt in the beam is evaluated on a subset of the validation dataset Dᵥₐₗ. The LLM model 108 generates outputs for each input in this subset using the current prompt candidate, and a performance metric Q (e.g., accuracy or F1 score) is calculated. This metric, μ^{k}, estimates the effectiveness of each candidate prompt based on its validation performance. For each candidate prompt, a UCB score is computed to balance exploration and exploitation. In one example, the UCB formal is:

$${UCB}_{k} ( t ) = {\hat{u}}_{k} + c \sqrt{\frac{log t}{{n}_{k}}}$$

where:
   μ^{k} is the candidate's estimated performance on Dᵥₐₗ
   nₖ is the number of times the candidate has been selected for evaluation,
   c is a hyperparameter that controls the exploration-exploitation trade-off,
   t is the current iteration number.

The UCB score ensures that candidates with fewer evaluations, but potentially high performance remain in consideration, encouraging the process to explore under-evaluated prompts while favoring high-performing ones. Candidate prompts may be stored in the tuning data store 204 during tuning. Upon completion of the tuning, candidate prompts may be deleted.

For the sake of simplicity, the above description was for a single prompt system. However, some systems use prompt chains that include multiple prompts. In a prompt chain, the LLM output of one prompt become the input to a second prompt. The technology described herein may optimize prompt chains. In many complex applications, tasks require not just a single prompt but a chain of interconnected prompts that generate intermediate outputs sequentially, leading to a final output. The optimization of such a chained prompt system presents unique challenges, as it involves tuning multiple prompts that depend on each other. In extending to a chained prompt system, a new prompt node type is introduced, which encapsulates each individual prompt as a self-contained hierarchical tree. This prompt node acts as a parent structure that contains all elements of a single prompt, following the same structuring rules as in the single prompt scenario.

Each prompt node in the chain may be annotated with a unique identifier for each prompt in the system and a sequential marker that specifies the order in which prompts are executed within the chain. These prompt nodes are then connected based on the sequence and dependencies of the different prompts, using sequential edges to establish the flow from one prompt to the next. Other details, such as hierarchical relationships within each prompt tree, remain the same as in single-prompt structuring. This approach enables the technology described herein to apply targeted optimizations within each prompt while ensuring that the prompt chain's execution order and inter-prompt dependencies are maintained effectively.

In the chained prompt system, the critic model 216 is extended to evaluate each prompt individually while considering the dependencies and flow across the entire sequence of prompts. The core mechanisms of generating reflections remain consistent with the single prompt system, but now the critic model 216 assesses each prompt within the broader context of the chain.

In the chained prompt system, there are preliminary reflections and error assessment reflections. As in the single prompt system, the preliminary reflection is generated without model predictions. However, for chained prompts, the critic model 216 reviews each prompt's structure and clarity within the full chain context. Reflections may identify sections where clarity or content adjustments are required to ensure consistency and coherence throughout the prompt chain.

The critic model 216 may also generate error assessment reflections. In the chained setting, the critic model 216 receives a batch containing the initial input for the chain, the target output at the end of the chain, and the outputs generated by each prompt in the chain, tagged with corresponding prompt IDs. The critic model 216 analyzes errors not only at the final output level but also within intermediate outputs, identifying potential issues specific to each prompt that may impact the entire chain's performance.

In chained prompts, reflection aggregation focuses on interdependencies between prompts. The critic model 216 groups reflections in two primary ways. Node reference-based aggregation groups reflections based on shared references to specific nodes within the hierarchical prompt tree. When multiple reflections address the same node, they are combined to create a unified set of recommendations for that node.

Similarity-driven aggregation groups reflections based on thematic or contextual similarities, such as shared input-output errors or related types of instructions, rather than node references. This approach relies on the ability to identify patterns across reflections that address similar errors or misinterpretations, even if they pertain to different nodes. This approach enables the method to apply targeted optimizations within each prompt while ensuring that the prompt chain's execution order and inter-prompt dependencies are maintained effectively.

In the chained prompt system, the actor model 214 adapts to handle dependencies and interactions between multiple interlinked prompts. While the fundamental approach of generating actions based on critic reflections remains the same, the actor model 214 must now consider the sequential and interdependent nature of the prompts in the chain. This adjustment allows for coordinated modifications across prompts to enhance the overall system performance.

For each reflection provided by the critic model 216, the actor model 214 generates actions that modify only the specific prompt when a reflection pertains to it. This may include updates to instructions, examples, or structural changes relevant solely to the individual prompt's function. For reflections involving multiple prompts, particularly where issues arise from misaligned data flow or sequential dependencies, the actor model 214 suggests coordinated actions across prompts. For example, if an intermediate output from Prompt A requires adjustment to better serve Prompt B, the actor model 214 generates actions for both prompts to maintain consistency.

In addition to the actions used in single-prompt optimization, the chained prompt system introduces three new actions to accommodate the interconnected structure. The first action allows the insertion of a new prompt in the sequence where additional processing or transformation is needed. The second action removes a prompt from the chain when its role becomes redundant or counterproductive, optimizing the sequence. The third action merges prompts that perform related tasks, combining their functionalities into a single prompt.

The actor model 214 may apply actions in the following sequence to maintain logical flow and minimize disruptions: Prompt-Specific Actions, which involve adjustments within individual prompts such as rephrasing or adding examples; cross-prompt actions, which involve modifications affecting multiple prompts executed in a coordinated manner to preserve chain consistency; and chain-level actions, which involve high-level actions such as adding, deleting, or merging prompts, executed last to ensure foundational adjustments are in place. By introducing these new action types and applying a structured order of operations, the actor model 214 optimizes each prompt while maintaining the cohesion and effectiveness of the entire prompt chain.

The search process for chained prompt systems follows the same structure as in single-prompt optimization, with one key modification: instead of evaluating individual prompt outputs, the focus is on the final output generated by the entire prompt chain. This approach ensures that all prompts work together effectively to produce the desired final result, optimizing the prompt chain as a cohesive system rather than as isolated parts.

In multi-task systems, prompts are designed to handle multiple outputs, potentially across different types of tasks within a single framework. These outputs may fall under categories such as classification, regression, ranking, or generation, each requiring tailored evaluation metrics to assess the model's performance effectively. Multi-task optimization aims to refine the system to balance these various outputs, ensuring overall task consistency and accuracy.

For classification tasks, where the goal is to assign inputs into predefined categories or classes, metrics like F1 Score and accuracy may be used. The F1 Score is particularly useful in cases of class imbalance, as it balances precision and recall. The F1 Score may be calculated as:

$$F 1 Score = \frac{2 \times ( Precision \times Recall )}{Precision + Recall}$$

Other potential metrics for classification tasks include accuracy and Matthews Correlation Coefficient (MCC), depending on the specific requirements of the task.

Regression tasks predict continuous values and are often evaluated using metrics like Mean Absolute Error (MAE) and Root Mean Squared Error (RMSE). For consistency with classification metrics, the MAE can be transformed to a score in the range [0, 1] as:

$$Regression Score = \frac{1}{1 + MAE}$$

This transformation facilitates a unified scoring system across tasks.

In ranking tasks, where the order of items is essential, metrics like Normalized Discounted Cumulative Gain (NDCG) or Mean Reciprocal Rank (MRR) are often used. For unified scoring, these metrics are typically scaled to fall within [0, 1].

For tasks involving text generation, BLEU (Bilingual Evaluation Understudy) and ROUGE (Recall-Oriented Understudy for Gisting Evaluation) are commonly used to evaluate the quality of generated text against reference outputs. These scores are naturally bounded between [0, 1].

To comprehensively evaluate multi-task systems that include a variety of outputs, a single aggregate score is necessary. The harmonic mean may be used for combining multiple scores as it emphasizes the contribution of each task equally, avoiding the risk of one type of task dominating others. For a system with multiple tasks, the harmonic mean score is calculated to ensure that even if one task's score is low, it is given due importance, balancing performance across tasks. The harmonic mean score is calculated as:

$$Harmonic Mean Score = \frac{N}{\frac{1}{{score}_{1}} + \frac{1}{{score}_{2}} + … + \frac{1}{{score}_{N}}}$$

This calculation ensures that even if one task's score is low, it is given due importance, balancing performance across tasks.

In some scenarios, certain tasks may be more critical than others, requiring a weighted approach. Weighted Harmonic Mean can assign higher weights to selected tasks, ensuring that they have a more significant impact on the overall score. For example, if tasks are weighted according to their importance as w₁, w₂, . . . , w_{N}, the Weighted Harmonic Mean is given by:

$$Weighted Harmonic Mean Score = \frac{{\sum }_{i = 1}^{N} {w}_{i}}{\frac{{w}_{1}}{{score}_{1}} + \frac{{w}_{2}}{{score}_{2}} + … + \frac{{w}_{N}}{{score}_{N}}}$$

Alternatively, a Dynamic Harmonic Mean can adjust weights based on real-time performance. For instance, if a specific task score is lagging behind others, the system can dynamically assign higher weight to this task, encouraging balanced improvements across all tasks. This approach ensures that the prompt system does not over-optimize for high-performing tasks while neglecting others.

The optimization process for multi-task systems may remain consistent with the core approach, regardless of whether it involves a single prompt or a chained prompt system. This ensures that, at each iteration, the critic model 216 and actor model 214 continue to refine prompts systematically by leveraging node-specific adjustments based on feedback. The prompt structuring, critic feedback, and actor response mechanisms are preserved across both single and chained prompt systems, allowing for a unified optimization workflow.

However, in the search process, a notable adjustment may be made to accommodate the multi-task nature of chained prompt systems. For these systems, the evaluation metric becomes a harmonic mean of individual task scores, ensuring a balanced assessment of all outputs produced by the system. This harmonic mean score acts as the guiding metric for maintaining the beam of candidate prompt systems.

Thus, rather than simply selecting candidates based on a single-task score, the search process evaluates each chained prompt system's overall performance across tasks. By using the harmonic mean to score the prompts, the tuning system can prioritize systems that exhibit balanced performance across all tasks, effectively ranking and selecting candidates for the beam that are strong across the spectrum of outputs. This approach ensures that the optimization process remains scalable and adaptable to both single and multi-prompt systems, ultimately producing robust and generalizable prompt configurations.

### System Efficiency Optimization

In aspects, system efficiency may be optimized with performance or in isolation. In other words, a high performing prompt may be optimized for efficiency with the goal of maintaining performance. In optimizing prompt systems, efficiency may be as crucial as performance, particularly in resource-constrained or real-time applications where prompt length directly impacts computational load. The goal of system efficiency optimization is to retain or improve upon the initial performance of a prompt system while minimizing its total token count. This is achieved by progressively refining and compressing the prompts within the system.

For a given prompt system, efficiency is quantified as the cumulative token count across all prompts in the system. Let each prompt Pᵢ in a prompt system P have a token count T(Pᵢ). Then, the total efficiency E(P) of the system is defined as:

$$E ( P ) = {\sum }_{i = 1}^{n} T ( {P}_{i} )$$

where n represents the total number of prompts in the system. Lower values of E(P) denote higher efficiency.

The challenge lies in balancing performance with efficiency to identify the most compact prompt system that at least matches the initial prompt system's performance but may also surpass it. To this end, the tuning system may use a combined metric that integrates both efficiency and performance, ensuring that while token usage is minimized, the quality of outputs does not suffer.

Given an initial prompt system Pᵢₙᵢₜᵢₐₗ with a performance score Q(Pᵢₙᵢₜᵢₐₗ), a target threshold for system performance, Q_{threshold}, may be defined as:

$${Q}_{threshold} = Q ( {P}_{initial} )$$

The optimization aims to select a prompt system P* that maximizes performance while minimizing token count, ensuring Q(P*)≥Q_{threshold}. The combined metric M(P) for each prompt system P is thus formulated as:

$$M ( P ) = \frac{Q ( P )}{E ( P )}$$

where Q(P) is the performance metric of the prompt system P (e.g., accuracy, F1 score, harmonic mean for multi-task systems), and E(P) is the efficiency metric. This metric M(P) serves as an efficiency-adjusted performance measure, balancing high performance with minimal token usage.

Using this combined metric M(P), the optimization process prioritizes prompt systems that maintain or exceed the threshold Q_{threshold} while striving to reduce token count. The system with the highest M(P) score is selected as the optimal, efficient prompt system:

$${P}^{*} = arg {max}_{P ∈ Candidates} M ( P )$$

In scenarios with a large number of candidate systems, beam search can be employed to iteratively explore and refine the most promising configurations based on the combined metric.

In the efficiency-optimized system, the critic model 216 is adapted not only to enhance the prompt's performance but also to identify opportunities for compression. This adapted critic model 216 evaluates prompts with a dual focus: maintaining or surpassing the initial performance threshold and reducing the total token count. After receiving an initial prompt system, the critic model 216 generates reflections aimed at identifying redundant sections, verbose language, and sections that could be combined or streamlined without losing crucial information.

For each prompt in the system, the critic model issues two types of reflections. The first type, performance-enhancing reflections, targets areas that require improvement to achieve or exceed the baseline performance threshold. These reflections guide the actor model 214 in refining the prompt's alignment with task requirements. The second type, efficiency-oriented reflections, highlights sections where token reduction is possible, such as redundant phrases, excessive examples, or overly detailed instructions. These reflections prompt the actor model 214 to apply actions aimed explicitly at shortening the prompt without compromising the task's objectives. Using these dual reflections, the system iteratively compresses the prompt system, with each refinement evaluated by the combined metric M(P)=Q(P)/E(P) his approach ensures that the prompt remains effective while being compressed as much as possible.

Another technique employed within the efficiency framework is direct rephrasing to reduce token count across the prompts. In this approach, the actor model 214 focuses on rephrasing, guided by the critic's reflections that specify sections where verbosity can be reduced. Direct rephrasing actions are implemented to condense language by simplifying phrasing and removing filler words, ensuring that instructions are conveyed in the shortest form possible without ambiguity. For example, long-winded explanations are rephrased into concise instructions. Additionally, examples are streamlined by reducing their number where appropriate, retaining only the most illustrative cases or rephrasing multiple examples into generalized statements. Where feasible, the actor model 214 merges sections with similar content, using rephrasing to summarize key points succinctly.

Each rephrased prompt system is then evaluated with the combined metric M(P) to determine if the performance threshold Q_{threshold} is met with the reduced token count. By systematically rephrasing each prompt within the system, this approach provides a direct means of achieving a more efficient prompt system. Through iterative rephrasing and evaluation, the system may stop at the prompt configuration that offers the best balance of performance and efficiency.

### Example Methods

Now referring to FIGS. 4, 5 and 6, each block of methods 400, 500, and 600, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The method may be provided by an operating system. In addition, methods 400, 500, and 600 are described, by way of example, with respect to FIGS. 1-3. However, these methods may additionally or alternatively be executed by any one system, or any combination of systems, including, but not limited to, those described herein.

FIG. 4 is a flow diagram showing a method 400 of generating a consolidated event explanation, in accordance with some embodiments of the present disclosure. Method 400 may be performed on or with systems like those described with reference to FIGS. 1-3.

As shown in FIG. 4, method 400 may include receiving a prompt (block 402). For example, device may receive a prompt, as described above. As also shown in FIG. 4, method 400 may include generating a hierarchical prompt tree from text in the prompt (block 404). For example, device may generate a hierarchical prompt tree from text in the prompt, as described above. As further shown in FIG. 4, method 400 may include providing the hierarchical prompt tree, a LLM output generated in response to the prompt combined with an input, and an expected output to a critic model (block 406). The input includes actual values that are inserted in placeholders within the prompt

As shown in FIG. 4, method 400 involves several key steps to optimize a prompt. Initially, the process includes generating a reflection at the critic model (block 408). The critic model evaluates the prompt's effectiveness and identifies areas for refinement. This feedback, known as reflections, may be generated in two types: preliminary reflections, which focus on the structural and semantic clarity of the prompt, and error assessment reflections, which focus on specific errors in the output. Efficiency reflections are also possible.

Next, the method includes providing the reflection and the hierarchical prompt tree of text to an actor model (block 410). The actor model translates these reflections into actionable modifications within the hierarchical prompt tree. It processes the aggregated feedback from both preliminary and error assessment reflections to determine and apply specific changes to the hierarchical prompt tree.

The actor model then generates a revised hierarchical prompt tree (block 412). This revised hierarchical prompt tree includes nodes and edges, where each node represents a specific component or segment of the prompt, such as instructions, headings, examples, or lists. The edges define the containment relationship between two nodes, indicating which node is contained within which parent node.

Following this, the method includes generating a revised prompt from the revised hierarchical prompt tree (block 414). The revised prompt may be created by converting the revised hierarchical prompt tree back into an unstructured prompt format by traversing the updated nodes according to the revised hierarchical prompt tree.

Finally, the method includes storing the revised prompt (block 416). This ensures that the optimized prompt is available for future use and can be further refined if necessary.

Although FIG. 4 shows example blocks of method 400, in some implementations, method 400 may include additional blocks, fewer blocks, different blocks, or differently arranged blocks than those depicted in FIG. 4. Additionally, or alternatively, two or more of the blocks of method 400 may be performed in parallel.

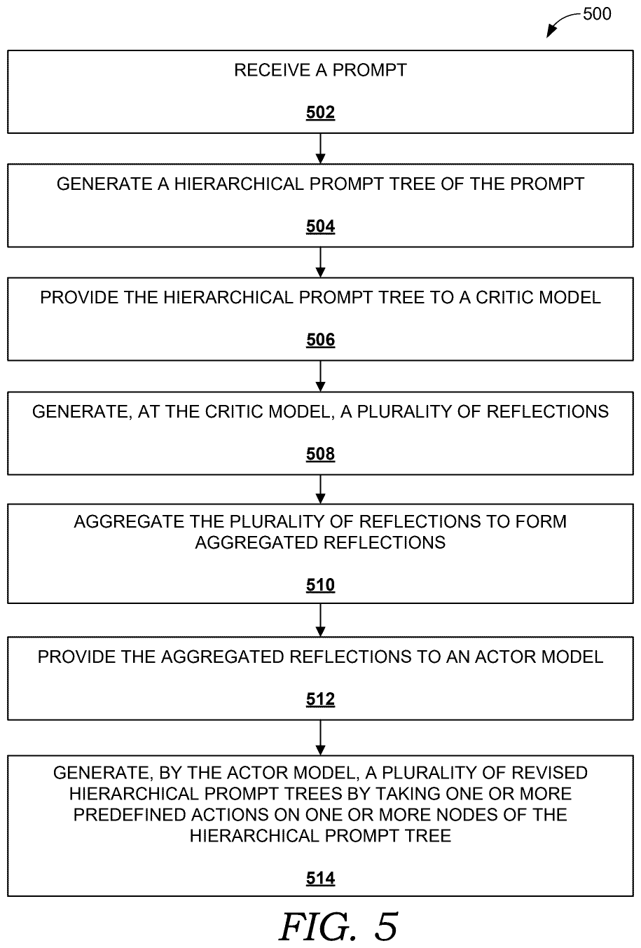

FIG. 5 is a flow diagram showing a method 500 of generating a consolidated event explanation, in accordance with some embodiments of the present disclosure. Method 500 may be performed on or with systems like those described with reference to FIGS. 1-3.

As shown in FIG. 5, method 500 involves several key steps to optimize a prompt. Initially, the process includes receiving a prompt (block 502). This step sets the foundation for the subsequent operations by defining the prompt that will be optimized.

Next, the method involves generating a hierarchical prompt tree from the text in the prompt (block 504). This hierarchical prompt tree includes nodes and edges, where each node represents a specific component or segment of the prompt, such as instructions, headings, examples, or lists. The edges define the containment relationship between two nodes, indicating which node is contained within which parent node.

The hierarchical prompt tree is then provided to a critic model (block 506). The critic model evaluates the prompt's effectiveness and identifies areas for refinement, providing feedback on how well the prompt guides the LLM to perform as intended. This feedback, known as reflections, may be generated in two types: preliminary reflections, which focus on the structural and semantic clarity of the prompt, and error assessment reflections, which focus on specific errors in the output.

The method further includes generating a plurality of reflections at the critic model (block 508). These reflections are then aggregated to form aggregated reflections (block 510). Aggregation ensures that the actor model can apply comprehensive refinements without redundancy or contradiction, balancing the impact of multiple reflections on the same or related nodes.

The aggregated reflections are then provided to an actor model (block 512). The actor model translates these reflections into actionable modifications within the hierarchical prompt tree. It processes the aggregated feedback from both preliminary and error assessment reflections to determine and apply specific changes to the hierarchical prompt tree.

The actor model generates a plurality of revised hierarchical prompt trees by taking one or more predefined actions on one or more nodes of the hierarchical prompt tree (block 514). Finally, the method includes generating a plurality of revised prompts from the plurality of revised hierarchical prompt trees (block 516) and storing the plurality of revised prompts (block 518). This ensures that the optimized prompts are available for future use and can be further refined if necessary.

Although FIG. 5 shows example blocks of method 500, in some implementations, method 500 may include additional blocks, fewer blocks, different blocks, or differently arranged blocks than those depicted in FIG. 5. Additionally, or alternatively, two or more of the blocks of method 500 may be performed in parallel.

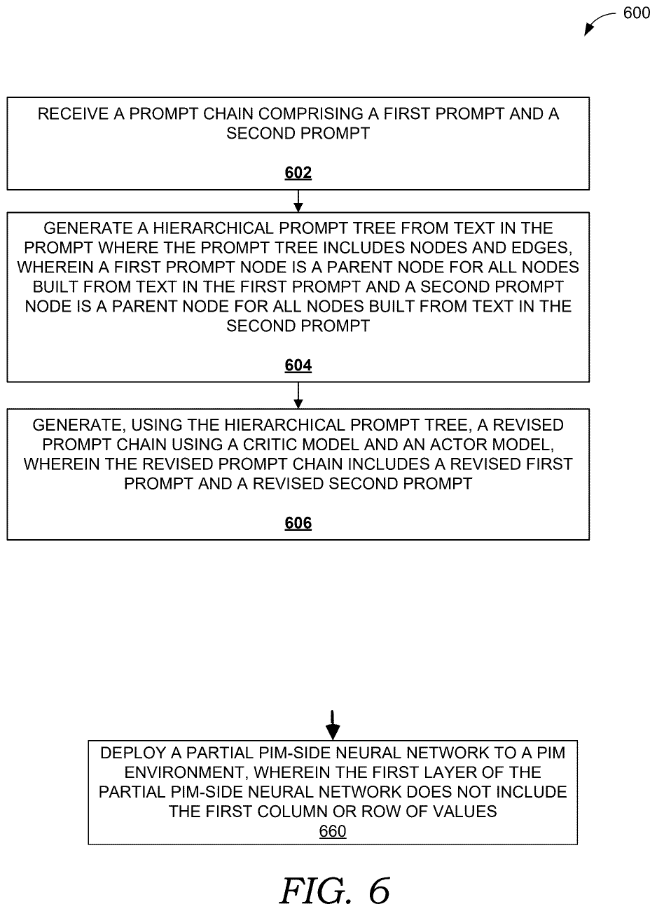

FIG. 6 is a flow diagram showing a method 600 of tuning a prompt, in accordance with some embodiments of the present disclosure. Method 600 may be performed on or with systems like those described with reference to FIGS. 1-3.

As shown in FIG. 6, method 600 involves several key steps to optimize a prompt chain. Initially, the process includes receiving a prompt chain that consists of a first prompt and a second prompt (block 602). This step sets the foundation for the subsequent operations by defining the prompts that will be optimized.

Next, the method involves generating a hierarchical prompt tree from the text in the prompt (block 604). This hierarchical prompt tree includes nodes and edges, where each node represents a specific component or segment of the prompt, such as instructions, headings, examples, or lists. The edges define the containment relationship between two nodes, indicating which node is contained within which parent node. In this context, a first prompt node acts as a parent node for all nodes built from the text in the first prompt, and a second prompt node serves as a parent node for all nodes built from the text in the second prompt.

Finally, the method includes generating a revised prompt chain using the hierarchical prompt tree, a critic model, and an actor model (block 606). The critic model evaluates the prompt's effectiveness and identifies areas for refinement, providing feedback on how well the prompt guides the LLM to perform as intended. This feedback, known as reflections, may be generated in two types: preliminary reflections, which focus on the structural and semantic clarity of the prompt, and error assessment reflections, which focus on specific errors in the output. In addition, the reflections can include efficiency reflections. The actor model then translates these reflections into actionable modifications within the hierarchical prompt tree, generating a revised hierarchical prompt tree. The revised prompt chain includes a revised first prompt and a revised second prompt, ensuring that the prompt chain's execution order and inter-prompt dependencies are maintained effectively.

Although FIG. 6 shows example blocks of method 600, in some implementations, method 600 may include additional blocks, fewer blocks, different blocks, or differently arranged blocks than those depicted in FIG. 6. Additionally, or alternatively, two or more of the blocks of method 600 may be performed in parallel.

### Example Operating Environment

Referring to the drawings in general, and initially to FIG. 7, an example operating environment for implementing aspects of the technology described herein is shown and designated generally as computing device 700. Computing device 700 is but one example of a suitable computing environment and is not intended to suggest any limitation as to the scope of use of the technology described herein. Neither should the computing device 700 be interpreted as having any dependency or requirement relating to any one or combination of components illustrated.

The technology described herein may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs tasks or implements abstract data types. The technology described herein may be practiced in a variety of system configurations, including handheld devices, consumer electronics, general-purpose computers, specialty computing devices, etc. Aspects of the technology described herein may also be practiced in distributed computing environments where tasks are performed by remote-processing devices that are linked through a communications network.

With continued reference to FIG. 7, computing device 700 includes a bus 710 that directly or indirectly couples the following devices: memory 712, one or more processors 714, one or more presentation components 716, input/output (I/O) ports 718, I/O components 720, and an illustrative power supply 722. Bus 710 represents what may be one or more busses (such as an address bus, data bus, or a combination thereof). Although the various blocks of FIG. 7 are shown with lines for the sake of clarity, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art and reiterate that the diagram of FIG. 7 is merely illustrative of a computing device that may be used in connection with one or more aspects of the technology described herein. Distinction is not made between such categories as “workstation,” “server,” “laptop,” “handheld device,” etc., as all are contemplated within the scope of FIG. 7 and refer to “computer” or “computing device.”

Computing device 700 typically includes a variety of computer-readable media. Computer-readable media may be any available media that may be accessed by computing device 700 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program models, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program models, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 712 includes computer storage media in the form of volatile and/or nonvolatile memory. The memory 712 may be removable, non-removable, or a combination thereof. Example memory includes solid-state memory, hard drives, optical-disc drives, etc. Computing device 700 includes one or more processors 714 that read data from various entities such as bus 710, memory 712, or I/O components 720. Presentation component(s) 716 present data indications to a user or other device. Example presentation components 716 include a display device, speaker, printing component, vibrating component, etc. I/O ports 718 allow computing device 700 to be logically coupled to other devices, including I/O components 720, some of which may be built in.

Illustrative I/O components include a microphone, joystick, game pad, satellite dish, scanner, printer, display device, wireless device, a controller (such as a stylus, a keyboard, and a mouse), a natural user interface (NUI), and the like. In aspects, a pen digitizer (not shown) and accompanying input instrument (also not shown but which may include, by way of example only, a pen or a stylus) are provided to digitally capture freehand user input. The connection between the pen digitizer and processor(s) 714 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may coexist with the display area of a display device, be integrated with the display device, or may exist as a separate device overlaying or otherwise appended to a display device. All such variations, and any combination thereof, are contemplated to be within the scope of aspects of the technology described herein.

An NUI processes air gestures, voice, or other physiological inputs generated by a user. Appropriate NUI inputs may be interpreted as ink strokes for presentation in association with the computing device 700. These requests may be transmitted to the appropriate network element for further processing. An NUI implements any combination of speech recognition, touch and stylus recognition, facial recognition, biometric recognition, gesture recognition both on screen and adjacent to the screen, air gestures, head and eye tracking, and touch recognition associated with displays on the computing device 700. The computing device 700 may be equipped with depth cameras, such as stereoscopic camera systems, infrared camera systems, RGB camera systems, and combinations of these, for gesture detection and recognition. Additionally, the computing device 700 may be equipped with accelerometers or gyroscopes that enable detection of motion. The output of the accelerometers or gyroscopes may be provided to the display of the computing device 700 to render immersive augmented reality or virtual reality.

A computing device may include a radio 724. The radio 724 transmits and receives radio communications. The computing device may be a wireless terminal adapted to receive communications and media over various wireless networks. Computing device 700 may communicate via wireless policies, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 policies.

### EMBODIMENTS

The technology described herein has been described in relation to aspects, which are intended in all respects to be illustrative rather than restrictive. While the technology described herein is susceptible to various modifications and alternative constructions, certain illustrated aspects thereof are shown in the drawings and have been described above in detail. It should be understood, however, that there is no intention to limit the technology described herein to the specific forms disclosed, but on the contrary, the intention is to cover all modifications, alternative constructions, and equivalents falling within the spirit and scope of the technology described herein.

What is claimed is:

1. One or more computer storage media comprising computer-executable instructions that when executed by computing device performs a method of tuning a prompt, the method comprising:
receiving a prompt;
generating a hierarchical prompt tree from text in the prompt;
providing the hierarchical prompt tree, a large language model (LLM) output generated in response to the prompt combined with an input, and an expected output to a critic model, wherein the input includes actual values that are inserted in placeholders within the prompt;
generating, at the critic model, a reflection;
providing the reflection and the hierarchical prompt tree of text to an actor model;
generating, by the actor model, a revised hierarchical prompt tree;
generating a revised prompt from the revised hierarchical prompt tree; and
storing the revised prompt.

2. The media of claim 1, wherein the method further comprises assigning a quality score to the revised prompt using a validation dataset, wherein each validation pair in a validation dataset includes an input and an expected LLM output.

3. The media of claim 1, wherein the reflection is an error assessment reflection generated by comparing the LLM output with an expected LLM output.

4. The media of claim 1, wherein the reflection is preliminary reflection generated by evaluating the hierarchical prompt tree without reference to an expected output.

5. The media of claim 1, wherein the reflection is an aggregation of multiple reflections.

6. The media of claim 1, wherein the actor model is limited to taking pre-defined actions on the hierarchical prompt tree.

7. The media of claim 6, wherein the pre-defined actions include a node deletion.

8. The media of claim 1, wherein the critic model includes a prompt communicated to an LLM asking for the reflection.

9. A method of tuning a prompt comprising:
receiving a prompt;
generating a hierarchical prompt tree of the prompt;
providing the hierarchical prompt tree to a critic model;
generating, at the critic model, a plurality of reflections;
aggregating the plurality of reflections to form aggregated reflections;
providing the aggregated reflections to an actor model;
generating, by the actor model, a plurality of revised hierarchical prompt trees by taking one or more predefined actions on one or more nodes of the hierarchical prompt tree;
generating a plurality of revised prompts from the plurality of revised hierarchical prompt trees; and
storing the plurality of revised prompts.

10. The method of claim 9, wherein the method further comprises assigning a quality score to each of the plurality of revised prompts using a validation dataset.

11. The method of claim 11, where the method further comprises applying a search method to select a subset of the plurality of revised prompts to be used as input to a subsequent iteration of prompt tuning.

12. The method of claim 12, wherein the search method is an Upper Confidence Bound based selection mechanism.

13. The method of claim 9, wherein at least one of the plurality of reflections is an error assessment reflection generated by comparing an LLM output with an expected LLM output.

14. The method of claim 9, wherein at least one of the plurality of reflections is an efficiency-oriented reflection that identifies a section where token reduction is possible.

15. The method of claim 9, wherein the predefined action is a node addition.

16. A method of tuning a prompt, comprising:
receiving a prompt chain comprising a first prompt and a second prompt;
generating a hierarchical prompt tree from text in the prompt chain where the prompt tree includes nodes and edges, wherein a first prompt node is a parent node for all nodes built from text in the first prompt and a second prompt node is a parent node for all nodes built from text in the second prompt;
generating, using the hierarchical prompt tree, a revised prompt chain using a critic model and an actor model, wherein the revised prompt chain includes a revised first prompt and a revised second prompt.

17. The method of claim 16, further comprising calculating a first quality score for the first prompt using a first metric and calculating a second quality score for the second prompt using a second metric, wherein the first metric and the second metric are different.

18. The method of claim 17, further comprising calculating a total quality score for the revised prompt chain using the first quality score and the second quality score.

19. The method of claim 18, further comprising calculating a total performance score for the revised prompt chain using the total quality score and an efficiency score that is a measure of how efficiently the LLM is able to process the revised prompt chain.

20. The method of claim 16, wherein the critic model is only provided incorrect LLM outputs.
